(19) United States
(12) Patent Application Publication
(10) Pub. No.: US 2005/0265210 A1
(43) Pub. Date: Dec. 1, 2005

(54) Optical disk, optical disk apparatus, and image recording method

(75) Inventors: Hiroshi Nakane, Fukaya-shi (JP); Mineharu Uchiyama, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/945,258

(22) Filed: Sep. 21, 2004

(30) Foreign Application Priority Data
May 31, 2004 (JP) 2004-161424

(51) Int. Cl. G11B 7/00; G11B 5/09; G11B 7/24

(52) U.S. Cl. 369/275.1; 369/275.3; 369/47.1

(57) ABSTRACT

An information recording type optical disk capable of recording a visible image by use of laser beam, including a disk substrate including an information recording layer on which recording marks indicating information is formed by the laser beam, a label recording layer which is formed on the disk substrate and on which the visible image can be recorded, and a reflective band disposed on one of an inner peripheral side and an outer peripheral side from the label recording layer and including a plurality of tracks each having a reflective surface formed in a disk peripheral direction.

### CROSS-REFERENCE TO RELATED APPLICATIONS

This application is based upon and claims the benefit of priority from prior Japanese Patent Application No. 2004-161424, filed May 31, 2004, the entire contents of which are incorporated herein by reference.

### BACKGROUND OF THE INVENTION

1. Field of the Invention

The present invention relates to an optical disk including a label recording layer capable of recording a visible image using laser beam on one surface of the disk.

2. Description of the Related Art

In recent years, as well known, optical disks such as CDs and DVDs have spread as information recording media. Examples of CDs include a read-only CD-ROM, a write-once (write-once at the same region in a disk) CD-R, a rewritable CD-RW, and examples of DVDs include a read-only DVD-ROM, a write-once DVD-R, a rewritable DVD-RAM, DVD-RW. A recording type optical disk, that is, a write-once or rewritable optical disk has an information recording layer. The recording capacity of the information recording layer is, for example, about 700 MB in the CD-R, or about 4.7 GB in DVD-R.

Characters or logos indicating the type or the like of a recording type optical disk are, for example, silk-screen printed on a label surface on a side opposite to that of an information recording layer of the disk. An optical disk including a label surface on which the characters or pictures can be recorded by an ink jet printer or handwriting has also become popular.

In recent years, documents on an optical disk and an optical disk apparatus capable of recording pictures or characters on the label surface using laser beam have been published, for example, in Jpn. Pat. Appln. KOKAI Publication No. 2002-203321.

When the characters or pictures are printed on the label surface printable by the laser beam as described above in an optical disk apparatus capable of recording information, a focus error signal having a sufficient S/N cannot be obtained, because a reflectance of the label surface is generally low. Focusing cannot be easily performed. Since there is no track in the label surface, tracking servo cannot be performed. That is, a position of the laser beam on the label surface cannot be correctly controlled, and a positional precision of a printed image cannot be raised. Therefore, the image printed on the label surface is sometimes decentered with respect to the disk.

### BRIEF SUMMARY OF THE INVENTION

An optical disk according to one embodiment of the present invention is an information recording type optical disk capable of recording a visible image on one surface thereof using laser beam, comprising: a disk substrate including an information recording layer on which a recording mark indicating information is formed using the laser beam; a label recording layer which is formed of a circle concentric with the disk substrate on the disk substrate and on which the visible image can be recorded; and a reflective band disposed on an inner peripheral side or an outer peripheral side of the label recording layer and including a plurality of tracks each having a reflective surface formed in a disk peripheral direction.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure of an optical disk according to one embodiment of the present invention;

FIG. 2 is an enlarged view showing a structure of a first embodiment of a reflective band 3a according to the present invention;

FIG. 3 is an enlarged view showing a structure of a second embodiment of the reflective band 3a according to the present invention;

FIG. 4 is a characteristic diagram showing a relation between a focus error signal and a reflected light signal;

FIG. 5 is a block diagram showing a constitution of an optical disk recording/reproducing device to which the present invention is applied; and

FIG. 6 is a flowchart showing an operation for focusing laser beam with respect to a label surface to perform tracking and for recording a visible image.

### DETAILED DESCRIPTION OF THE INVENTION

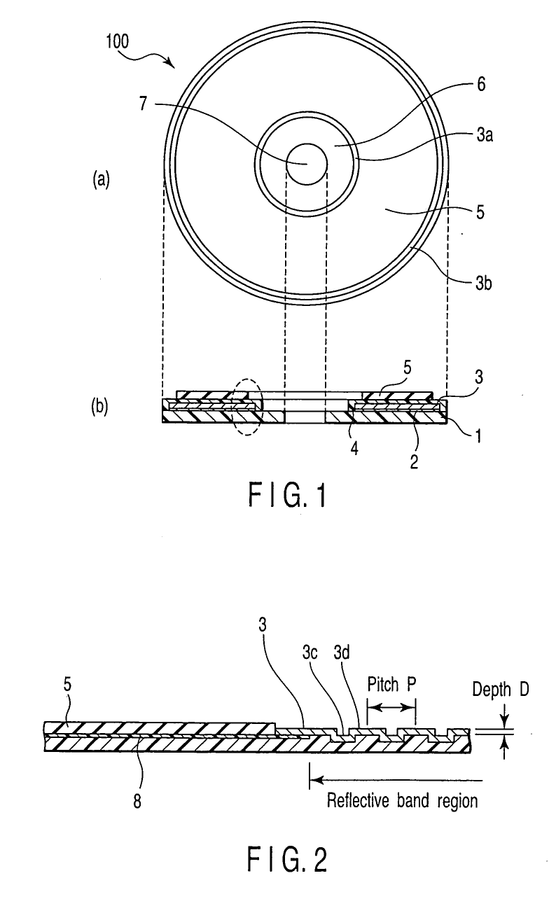

FIG. 1 is a diagram showing a structure of an information recording type optical disk 100 according to one embodiment of the present invention, (a) of FIG. 1 is a plan view, and (b) of FIG. 1 is a sectional view.

The optical disk 100 is an information recording type disk, and includes an information recording surface on one side thereof and a label surface on the other side. (a) of FIG. 1 is a diagram of the optical disk 100 viewed from the label surface. A label recording layer 5 is formed of, for example, a circle concentric with the disk 100 on the side of the label surface of the disk 100. A visible image can be printed on the label recording layer 5 using laser of an optical disk apparatus. A reflective band 3a is disposed on an inner periphery from the label recording layer 5, that is, between the label recording layer 5 and a clamp area 6, and a reflective band 3b is also formed of a circle concentric with the optical disk 100 on an outer peripheral side from the label recording layer 5.

As shown in (b) of FIG. 1, an information recording layer 2 is formed on a substrate 1, and a reflective layer 3 is formed on the recording layer. On the information recording layer 2, a recording mark indicating information can be formed by laser beam. A protective film 4 is formed in such a manner as to coat the reflective layer 3, and the label recording layer 5 is formed on the film.

A write-once optical disk such as a DVD-R includes the information recording layer 2 containing such a dyestuff that a reflectance of a laser applied portion permanently changes, and the recording mark indicating the information is formed using the laser beam to record/reproduce the information. A rewritable optical disk such as a DVD-RAM or DVD-RW includes the information recording layer 2 whose phase changes upon laser irradiation, and the recording mark indicating the information is formed using the laser beam to record/reproduce and rewrite the information. This also applies to a CD-R and CD-RW.

FIG. 2 is an enlarged view showing a structure of a first embodiment of the reflective band 3a (portion shown by an ellipse in (b) of FIG. 1) which is a characteristic of the present invention. Grooves 3c each having a depth D are disposed at a pitch P in a circle concentric with the optical disk 100 or in a spiral form in a region of the reflective band on the side of the label surface of the substrate 1, and a reflective material is vapor-deposited in the grooves to constitute the reflective band. A convex portion 3d formed between the adjoining grooves 3c, and (or) the groove 3c are formed as tracks for checking eccentricity of the disk, driving properties or the like of an actuator which moves a laser beam spot in a radial direction of the disk, and the like. In a groove region 8, grooves are formed as information tracks for recording the information from the side of the information recording surface (lower side in the figure) of the optical disk 100.

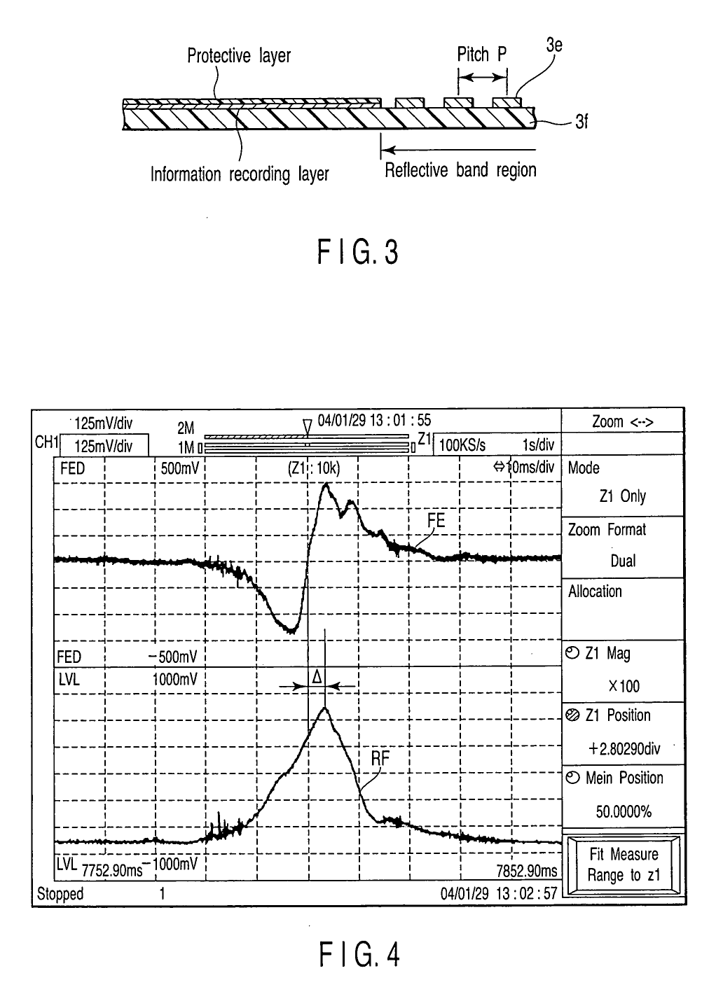

FIG. 3 is an enlarged view showing a structure of a second embodiment of the reflective band 3a (portion shown by the ellipse in (b) of FIG. 1) which is a characteristic of the present invention. Tracks 3e formed of reflective materials are formed at a pitch P on the substrate. The tracks 3e are formed using, for example, masking or printing, when the reflective material of the reflective layer 3 is vapor-deposited on the side of the label surface of the substrate. In this case, high-reflectance tracks 3e and low-reflectance tracks 3f by the substrate 1 are alternately disposed in the radial direction of the disk.

FIG. 4 is a characteristic diagram showing a relation between a focus error signal FE and a sum signal RF based on light reflected by the disk surface. The total added signal RF is used as the sum signal.

The optical disk apparatus is optically designed in such a manner as to cancel aberration at a point at which the laser beam passed through a medium having a certain thickness reaches the surface of the recording layer. Therefore, when the laser beam is directly applied to the surface of the disk as in the reflective band of the present invention, the aberration is deteriorated, and a spot has a size of 10 to 50 μm. Therefore, the pitch P is set to 10 to 50 μm, and the depth D is set to λ/4 to λ/8 assuming that a wavelength of the laser beam is λ.

Next, the focusing and tracking with respect to the label surface of the optical disk 100 according to the present invention will be described.

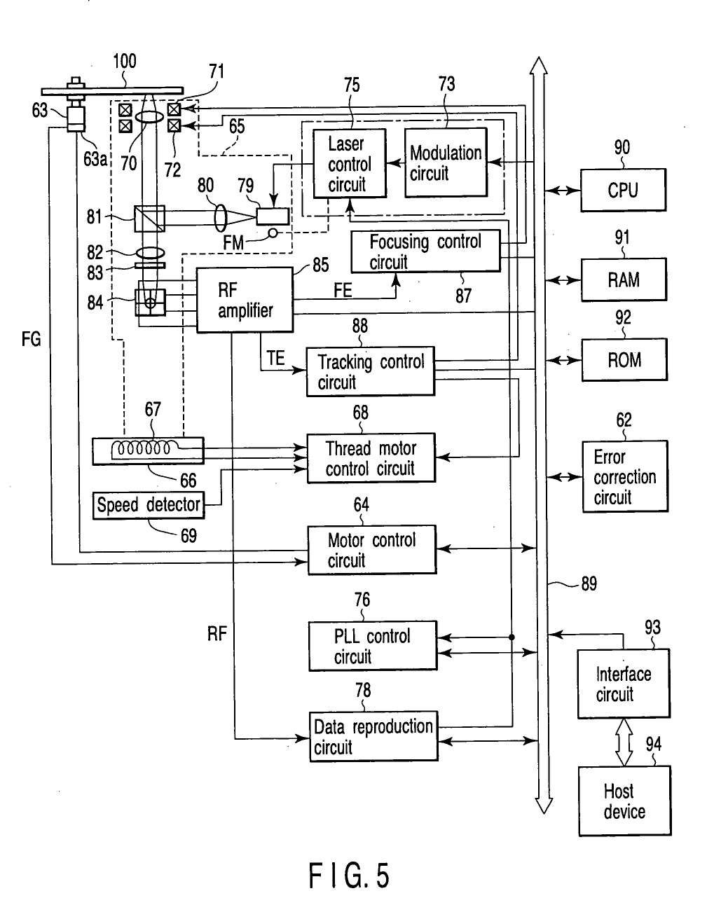

FIG. 5 is a block diagram showing a constitution of an optical disk recording/reproducing device to which one embodiment of the present invention is applied.

Land tracks and groove tracks are formed into a spiral form on the surface of the optical disk 100. The disk 100 is rotated/driven by a spindle motor 63. FG pulses are supplied from a rotation detector 63a disposed in the spindle motor 63. For example, five FG pulses are produced for every rotation of the spindle motor 63 (disk 100). A rotation angle and a rotation speed of the disk 100 can be calculated by the FG pulses.

The information is recorded/reproduced with respect to the optical disk 100 by an optical pickup head (PUH) 65. The optical pickup head 65 is connected to a thread motor 66 via a gear, and the thread motor 66 is controlled by a thread motor control circuit 68.

A speed detection circuit 69 is connected to the thread motor control circuit 68, and a speed signal of the optical pickup head 65 detected by the speed detection circuit 69 is sent to the thread motor control circuit 68. A permanent magnet (not shown) is fixed in the thread motor 66, a driving coil 67 is energized by the thread motor control circuit 68, and accordingly the optical pickup head 65 moves in a radial direction of the optical disk 100.

An objective lens 70 supported by a wire or a leaf spring (not shown) is disposed in the optical pickup head 65. The objective lens 70 is movable in a focusing direction (optical axial direction of the lens) by the driving of a driving coil 72, and is movable in a tracking direction (direction crossing an optical axis of the lens at right angles) by the driving of a driving coil 71.

A modulation circuit 73 subjects user data supplied from a host device 94 via an interface circuit 93, for example, to 8-14 modulation (EFM) to provide EFM data at the time of the recording of the information. A laser control circuit 75 supplies a writing signal to a laser diode 79 based on the EFM data supplied from the modulation circuit 73 at the time of the recording of the information (forming of a marks). The laser control circuit 75 supplies a reading signal smaller than the writing signal to the laser diode 79 at the time of the reading of the information.

A front monitor FM constituted of a photo diode detects a quantity, that is, a light emitting power of laser beam produced by the laser diode 79, and supplies a detected current to the laser control circuit 75. The laser control circuit 75 controls the laser diode 79 in such a manner as to emit the light with the laser power set by a CPU 90 for the time of the reproducing/recording, based on the detected current from the front monitor FM.

The laser diode 79 produces the laser beam in response to a signal supplied from the laser control circuit 75. The laser beam emitted from the laser diode 79 is applied onto the optical disk 100 via a collimator lens 80, a half prism 81, and the objective lens 70. Reflected light from the optical disk 100 is guided to a photo detector 84 via the objective lens 70, the half prism 81, a condenser lens 82, and a cylindrical lens 83.

The photo detector 84 is constituted of, for example, four divided photo detecting cells, and detection signals of these photo detection cells are output to an RF amplifier 85. The RF amplifier 85 processes signals from the photo detection cells to produce a focus error signal FE indicating an error from an in-focus position, a tracking error signal TE indicating an error between a center of a beam spot of laser beam and a center of the track, and an RF signal which is a total added signal of photo detection cell signals.

The focus error signal FE is supplied to a focusing control circuit 87. The focusing control circuit 87 produces a focus driving signal in response to the focus error signal FE. The focus driving signal is supplied to the driving coil 71 in the focusing direction. Accordingly, focus servo is performed in such a manner that the laser beam is constantly exactly focused on the recording film of the optical disk 100.

The tracking error signal TE is supplied to a tracking control circuit 88. The tracking control circuit 88 produces a track driving signal in response to the tracking error signal TE. The track driving signal output from the tracking control circuit 88 is supplied to the driving coil 72 in the tracking direction. Accordingly, tracking servo is performed to constantly trace the laser beam on the track formed in the optical disk 100.

When the focus servo and the tracking servo are performed, changes of the reflected light from pits or marks formed on the track of the optical disk 100 in accordance with recorded information are reflected in the total added signal RF of the output signals of the respective photo detection cells of the photo detector 84. The signal is supplied to a data reproduction circuit 78. The data reproduction circuit 78 reproduces recorded data based on a reproducing clock signal from a PLL control circuit 76.

While the objective lens 70 is controlled by the tracking control circuit 88, the thread motor 66 that is the PUH 65 is controlled by the thread motor control circuit 68 in such a manner as to position the objective lens 70 in the vicinity of a predetermined position in the PUH 65.

A motor control circuit 64, the thread motor control circuit 68, the laser control circuit 75, the PLL control circuit 76, the data reproduction circuit 78, the focusing control circuit 87, the tracking control circuit 88, an error correction circuit 62 and the like are controlled by the CPU 90 via a bus 89. The CPU 90 generally controls the recording/reproducing device in accordance with an operation command provided from the host device 94 via the interface circuit 93. The CPU 90 uses a RAM 91 as a working area, and performs a predetermined operation in accordance with control programs including a program recorded in a ROM 92 according to the present invention.

A controls of focus and tracking of the laser beam with respect to the surface of the disk (label surface) having a high surface roughness according to the present invention will be described hereinafter.

As described above, the optical disk apparatus is optically designed in such a manner that aberration is canceled at a point at which the laser beam passed through a medium having a certain thickness reaches the surface of the recording layer. Therefore, when the laser beam is directly applied to the surface of the label surface of the disk, a 0 point of the focus error signal differs from a maximum point of the sum signal (this is a desired exact focus point) by the spherical aberration as shown by difference/in FIG. 4. Since the maximum point of the sum signal is in the vicinity of a vertex of an S-shape of focus error signal characteristics, a servo control cannot be performed using the focus error signal in such a manner as to maximize the sum signal. As a result, a clear character or picture image cannot be printed on the label surface.

In the present invention, in order that the laser beam is focused with respect to the surface of the disk having a high surface roughness, firstly, the optical pickup head 65 (laser beam) is moved to the reflective band 3a or 3b, which is a portion disposed on the disk and having a satisfactory surface smoothness and a high reflectance. Then, a feedback control is performed in such a manner that the focus error signal turns to 0. A servo gain adjustment, an offset adjustment of various signals and the like are performed in this state. A focus driving indication values (output signal values of the focusing control circuit 87) are stored into a memory in a state in which the feedback control (focus servo) is performed. Thereafter, the feedback control is turned off, and a feedforward control is performed using values stored in the memory. An offset is added to a focus driving indicator voltage in such a manner as to maximize the sum signal in a state in which the feedforward control is performed, and accordingly a difference between the 0 point on the S shape of the focus error signal and the maximum point of the sum signal is canceled.

The eccentricity of the disk is measured from an actuator driving current of tracking servo in the reflective band 3a or 3b. A relation between a moving distance of the laser beam on the disk and a tracking driving force is learned by a track jumping in the reflective band 3a or 3b. The position of the pickup on the label surface at the time of printing is controlled based on the measured eccentricity of the disk, and the relation between the moving distance of the laser beam and the tracking driving force.

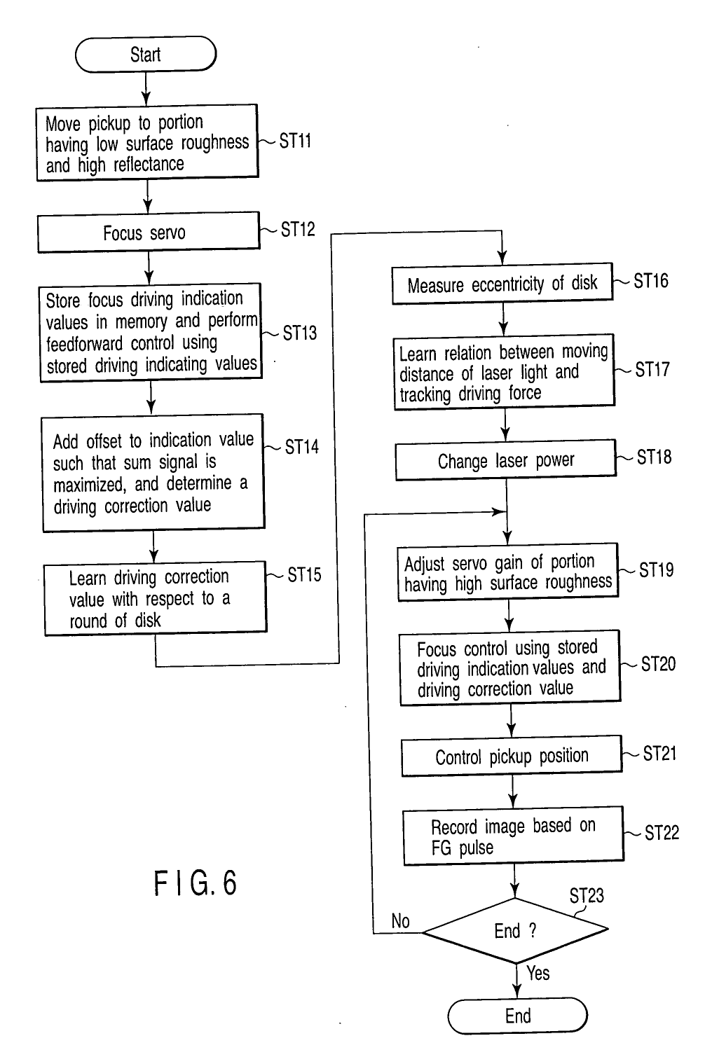

An embodiment of an operation by the present invention will be described hereinafter in detail. FIG. 6 is a flowchart showing an operation in which the laser beam is focused and tracked with respect to the surface of the disk having a high surface roughness, that is, the label surface to record a visible image. Each step of the flowchart is executed by control of a corresponding block in the optical disk apparatus shown in FIG. 5 by the CPU 90. First, the optical disk 100 is attached to the optical disk apparatus with the label surface directed downwards (on a pickup side), and printing image data is stored in a RAM 91 from a host device 94.

Step ST11: First, the pickup head (laser beam) is moved to the reflective band 3a or 3b disposed on the disk and having a low surface roughness and a high reflectance.

Step ST12: A feedback control (focus servo) is performed using the focus error signal as described above. At this time, the focus error signal is passed through an LPF having a cutoff frequency of 5 kHz or less and used in the focus servo. A servo gain adjustment, an offset adjustment of various signals and the like are performed in this step.

Step ST13: The focus driving indication value (an output signal value of the focusing control circuit 87) with respect to each rotation angle is stored into a memory under the feedback control. The rotation angle is judged from the FG pulses. A surface warp of the disk is stored in this manner. When the focus driving indication value is stored in the memory, in order to remove signal components following the surface roughness of the disk surface, the focus driving indication value is filtered through the LPF having a cutoff frequency of 1 kHz or less and stored. Thereafter, the feedback control of the focus is turned off, and a feedforward control is performed using the focus driving indication value stored in the memory.

Step ST14: The focus driving indication value is offset in such a manner that the sum signal (total added signal RF) is maximized under the feedforward control. At this time, the offset is gradually increased for example, and if the sum signal is reduced, the offset is gradually decreased. In this way, an offset value at which the sum signal is maximized is detected. The detected offset value is determined as a driving correction value and stored into a memory. The driving correction value corresponds to the difference [symbol] in FIG. 4. The driving correction value means difference between a focus indication value at a point at which the focus error signal turns to zero, and that at a point at which the sum signal is maximized.

Step ST15: The driving correction value is learned with respect to a round of the disk. That is, the driving correction value is determined with respect to each rotation angle, and the determined driving correction values are stored into the memory. The rotation angle is judged from the FG pulse. Note that, a change of the driving correction value is usually small with respect to a round of the disk. thus, this step may be omitted.

Step ST16: Tracking servo is performed in the reflective band, and the eccentricity of the disk is measured from an actuator driving force in the tracking servo, and stored.

Step ST17: The pickup 65 is jumped to a adjoining track to learn the relation between the moving distance of the laser beam on the disk and the tracking driving force.

Step ST18: The pickup is moved to a portion (label recording surface) having a high surface roughness, and a laser power is changed in such a manner that a signal amplitude is substantially equal to that of a reflective band region having a high reflectance.

Step ST19: A focus error signal amplitude or a sum signal amplitude at the reflective band region 3a or 3b subjected to the servo gain adjustment is compared with that at the region having the high surface roughness (label recording surface). A servo gain at the region having the high surface roughness is determined in accordance with the amplitude difference.

Step ST20: A focus control is performed using the driving indication values obtained in the step ST13 and the driving correction value(s) obtained in the step ST14 or the step ST15. That is, the focus driving indication value is corrected by (or added to) the correction value and the focus control is performed using the corrected focus driving indication value.

Step ST21: The position of the pickup in the label surface at the time of the printing is controlled based on the measured eccentricity of the disk and the relation between the moving distance of the laser beam and the tracking driving force.

Step ST22: The printing image data is read from the RAM 91, and a rotation angle of the disk is confirmed based on the FG pulses, while the laser beam is produced with a power in accordance with the printing image data to record visible images of characters or pictures on the label surface.

When the recording of the visible image does not end (NO in step ST23), the process of the steps ST19 to ST22 is repeated.

It is to be noted that the operation of the steps ST11 to ST17 is repeated at every predetermined time interval during the recording of the visible image to update learned data concerning the focusing and the tracking, and the focusing and the position of the pickup may also be controlled using latest learned data. To record other image in a new region, the process of the steps ST11 to ST18 is performed in the reflective band closest to the new region to update the learned data concerning the focusing and the tracking.

As described above, according to the present invention, there are provided an optical disk and an optical disk apparatus in which the focusing and the position of the pickup are easily controlled with respect to the label surface capable of recording the visible image using the laser beam.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An information recording type optical disk capable of recording a visible image by use of laser beam, comprising:
a disk substrate including an information recording layer on which recording marks indicating information is formed by the laser beam;
a label recording layer which is formed on the disk substrate and on which the visible image can be recorded; and
a reflective band disposed on one of an inner peripheral side and an outer peripheral side from the label recording layer and including a plurality of tracks each having a reflective surface formed in a disk peripheral direction.

2. The optical disk according to claim 1, wherein a pitch of the track is set to a range of 10 to 50 μm.

3. The optical disk according to claim 1, wherein the surface of the reflective band includes a plurality of grooves formed in the disk peripheral direction.

4. The optical disk according to claim 3, wherein a depth of the groove is set to λ/4 to λ/8, assuming a wavelength of the laser beam is λ.

5. An optical disk apparatus which records and reproduces information with respect to an optical disk including: a label recording surface on which a label recording layer capable of recording a visible image by use of laser beam and a reflective band including a plurality of tracks each including a reflective surface formed in a peripheral direction of the disk on one of an inner peripheral side of an outer peripheral side from the label recording layer are formed; and an information recording surface on which information is formed as recording marks on the track, the apparatus comprising:
a focus servo section which moves the laser beam onto the reflective band of the disk and performs focus servo to store a focus driving indication value during the focus servo in a memory;
a focusing section which corrects the focus driving indication value to perform a focusing control by use of the corrected focus driving indication value;
a learning section which performs track jump to an adjoining track to learn a relation between a tracking driving force and a moving distance of the laser beam in a state in which the focusing control is performed by the focusing section in the reflective band;
a position control section which controls a position of a pickup on the label recording surface based on a relation between the tracking driving force and the moving distance of the laser beam; and
a section which produces the laser beam with a power in accordance with printing image data to record the visible image on the label recording surface.

6. The optical disk apparatus according to claim 5, further comprising:
an eccentricity measurement section which performs tracking servo in the reflective band and which measures eccentricity of the disk from an actuator driving force in the tracking servo to store the eccentricity,
wherein the position control section controls the position of the pickup on the label recording surface based on the relation between the tracking driving force and the moving distance of the laser beam and the eccentricity of the disk measured by the eccentricity measurement section.

7. An image recording method to record a visible image in a label recording layer in an optical disk apparatus to record and reproduce information with respect to an optical disk including: a label recording surface on which a label recording layer capable of recording a visible image by use of laser beam and a reflective band including a plurality of tracks each including a reflective surface formed in a peripheral direction of the disk on an inner peripheral side or an outer peripheral side from the label recording layer are formed; and an information recording surface on which information is formed as a recording mark on the track, the method comprising:
moving the laser beam onto the reflective band of the disk to perform focus servo to record a focus driving indication value during the focus servo in a memory;
jumping to the adjoining track in the reflective band to learn a relation between a tracking driving force and a moving distance of the laser beam;
correcting the focus driving indication value to perform a focusing control by use of the corrected focus driving indication value;
controlling a position of a pickup on the label recording surface based on the relation between the tracking driving force and the moving distance of the laser beam; and
producing the laser beam with a power in accordance with printing image data to record the visible image on the label surface.

8. The image recording method according to claim 7, further comprising:
performing tracking servo in the reflective band, and measuring eccentricity of the disk from an actuator driving force in the tracking servo,
wherein the controlling of the position of the pickup comprises: controlling the position of the pickup on the label recording surface based on the relation between the tracking driving force and the moving distance of the laser beam and the measured eccentricity of the disk.
